(19) United States
(12) Patent Application Publication
(10) Pub. No.: US 2009/0081550 A1
(43) Pub. Date: Mar. 26, 2009

(54) NON-AQUEOUS ELECTROLYTE SECONDARY BATTERY AND METHOD FOR PRODUCING THE SAME

(76) Inventors: Toshihiro INOUE, Osaka (JP); Ryuichi Kuzuo, Ehime (JP); Hideo Sasaoka, Ehime (JP)

Correspondence Address: MCDERMOTT WILL & EMERY LLP, 600 13TH STREET, NW, WASHINGTON, DC, 20005-3096, US

(21) Appl. No.: 12/211,323

(22) Filed: Sep. 16, 2008

(30) Foreign Application Priority Data
Sep. 21, 2007 (JP) 2007-245865

(51) Int. Cl. H01M 4/52; H01M 4/40; H01M 4/26

(52) U.S. Cl. 429/223; 423/332

(57) ABSTRACT

To curb a decline in the high-rate performance of non-aqueous electrolyte secondary batteries and improve safety at the time of an internal short circuit, a non-aqueous electrolyte secondary battery includes a positive electrode, a negative electrode, a separator, and a non-aqueous electrolyte wherein the positive electrode includes a positive electrode active material capable of absorbing and desorbing lithium ions, the positive electrode active material includes a secondary particle, and the secondary particle is an aggregate containing primary particles and a silicon oxide. The primary particles contain a lithium nickel composite oxide. The silicon oxide is present in at least grain boundaries between the primary particles.

### FIELD OF THE INVENTION

The present invention relates to non-aqueous electrolyte secondary batteries, particularly to an improvement of a positive electrode active material included in non-aqueous electrolyte secondary batteries.

### BACKGROUND OF THE INVENTION

With electronic devices such as mobile phones and notebook personal computers increasingly becoming small-size and lightweight recently, secondary batteries as a power source for these devices have been required to have high capacity. For the secondary battery, a non-aqueous electrolyte secondary battery including a positive electrode containing a lithium cobalt oxide as the positive electrode active material and a negative electrode containing a carbon material has been developed and widely used.

Cobalt contained in a lithium cobalt oxide is relatively expensive, and therefore development for a alternative material using other metal oxide has been required. For example, a lithium nickel oxide (LiNiO₂), and a lithium nickel composite oxide (for example, LiNi₁₋ₓCoₓO₂) in which a part of nickel in LiNiO₂ is replaced with Co or Mn have been proposed.

The cost of lithium nickel composite oxides is low compared with lithium cobalt oxides, and therefore lithium nickel composite oxides have been considered as promising as the positive electrode active material. Lithium nickel composite oxides are also high in energy density compared with lithium cobalt oxides, and therefore can improve the capacity of the non-aqueous electrolyte secondary battery.

However, since lithium nickel composite oxides are low in thermal stability compared with lithium cobalt oxides, safety of the battery is low. Thus, a means for improving safety of non-aqueous electrolyte secondary batteries containing lithium nickel composite oxides has been examined so far.

There has been proposed in Patent Document 1 (Japanese Laid-Open Patent Publication No. Hei 11-317230) that the active material particles are coated with a metal alkoxide sol and then heat-treated, to allow the surface of the active material particles to be coated with a metal oxide for improving battery safety. As the positive electrode active material, a compound represented by LiA_{1-x-y}BₓC_{y}O₂ is used. A is an element selected from the group consisting of Ni, Co, Mg, Ca, Sr, Ba, Ti, V, Cr, Fe, Cu, and Al. B is an element selected from the group consisting of Ni, Co, Mn, B, Mg, Ca, Sr, Ba, Ti, V, Cr, Fe, Cu, and Al. C is an element selected from the group consisting of Ni, Co, Mn, B, Mg, Ca, Sr, Ba, Ti, V, Cr, Fe, Cu, and Al. The metal oxide includes a metal element selected from the group consisting of Mg, Al, Co, K, Na, and Ca.

The positive electrode active material of Patent Document 2 (Japanese Laid-Open Patent Publication No. Hei 6-236756) contains an aggregate of polycrystalline particles of a metal compound, and ultrafine powder. The ultrafine powder is present, either in the polycrystalline particle or at the grain boundary of the polycrystalline particles, or both. As the ultrafine powder, Si₃N₄, SiC, and Al₂O₃ have been proposed. There have been also proposed in Patent Document 2 a manufacturing method in which ultrafine powder is added to a raw material of a metal compound and then the mixture is heated and baked; and a manufacturing method in which ultrafine powder is added to a solution containing metal ions to produce a precipitate along with the metal ions, and then the precipitate is heated and baked.

To secure sufficient safety in non-aqueous electrolyte secondary batteries, it seems effective to curb reactions involving a lithium nickel composite oxide, to prevent abnormal heat generation at the time of an internal short circuit. The safety of batteries can be evaluated by, for example, conducting a nail penetration test on the batteries.

When an internal short circuit has occurred, the Joule heat generates at the short circuit portion in the battery. Such heat causes thermal decomposition of the active material, and side reactions such as a reaction between the active material surface and the electrolyte occur. Since these side reactions involve further heat generation, they may be considered as a cause for abnormal heat generation in batteries.

The above-described thermal decomposition reaction of the active material includes a reaction in which oxygen is released from the active material surface. The reaction between the active material surface and the electrolyte includes electrolyte decomposition reactions. As a result of various examinations, it has become clear that these side reactions tend to advance at active points provided by for example lattice defects on the active material surface.

The positive electrode active material for lithium secondary batteries in Patent Document 1 is coated with a metal oxide on the whole surface of the active material, and therefore the activity of the entire surface of the positive electrode active material seems to decline. Therefore, the thermal decomposition reaction of the positive electrode active material and the reaction between the active material and the electrolyte are curbed. However, since the metal oxide included in the coating will not be involved in the battery reaction, sufficient high-rate performance at low temperature probably cannot be obtained.

In Patent Document 2, a strong bond cannot be formed between the polycrystalline particles and the ultrafine powder. This seems to be the reason why thermal stability of the lithium nickel composite oxide cannot be improved sufficiently. The presence or absence of the bond between the polycrystalline particles and the ultrafine powder can be checked, for example, by using an extended X-ray absorption fine structure (EXAFS).

In view of the above, an object of the present invention is to curb a decline in high-rate performance, and realize improved safety at the time of an internal short circuit in a non-aqueous electrolyte secondary battery containing a lithium nickel composite oxide as the positive electrode active material.

### BRIEF SUMMARY OF THE INVENTION

The present invention relates to a non-aqueous electrolyte secondary battery including a positive electrode; a negative electrode; a separator; and a non-aqueous electrolyte, wherein the positive electrode includes a positive electrode active material capable of absorbing and desorbing lithium ions, the positive electrode active material includes a secondary particle, the secondary particle includes an aggregate containing primary particles and a silicon oxide, the primary particles include a lithium nickel composite oxide, and the silicon oxide is present in at least grain boundaries between the primary particles.

The grain boundaries between the primary particles where the silicon oxide is present are preferably present inside the secondary particle.

The lithium nickel composite oxide is preferably represented by the general formula

LiₓNi_{1-y-z}Co_{y}Me_{z}O₂

where 0.85≦x≦1.25, 0<y≦0.5, 0≦z≦0.5, 0<y+z≦0.75, and Me is at least one selected from the group consisting of Al, Mn, Ti, and Ca.

Atomic ratio D(s) of silicon element contained in the silicon oxide relative to the metal element other than lithium contained in the lithium nickel composite oxide preferably satisfies 0.0002≦D(s)≦0.05, and the conductivity of the secondary particle under a load of 40 N/cm² is preferably 0.07 S/cm or less.

The secondary particle is preferably substantially spherical, and its circularity is preferably 0.88 or more.

The present invention also relates to a method for producing a non-aqueous electrolyte secondary battery, the method comprising the steps of: mixing a compound containing nickel, a compound containing lithium, and a compound containing silicon to prepare a mixture; and baking the mixture to prepare a positive electrode active material.

The producing method of the present invention preferably further includes the steps of: washing the positive electrode active material by mixing the positive electrode active material with an aqueous alkaline solution. The aqueous alkaline solution preferably does not substantially include lithium ions, and the amount of the positive electrode active material relative to 1 L of the aqueous alkaline solution is preferably 300 g to 3000 g.

According to the present invention, with a non-aqueous electrolyte secondary battery including a lithium nickel composite oxide as the positive electrode active material, a decline in high-rate performance can be curbed, and safety at the time of an internal short circuit can be further improved.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a diagram conceptually illustrating grain boundaries of primary particles contained in a secondary particle of a positive electrode active material.

FIG. 2 is a vertical cross sectional view of a non-aqueous electrolyte secondary battery in one embodiment of the present invention.

### DETAILED DESCRIPTION OF THE INVENTION

A non-aqueous electrolyte secondary battery of the present invention includes a positive electrode, a negative electrode, a separator, and a non-aqueous electrolyte. The positive electrode contains a positive electrode active material capable of absorbing and desorbing lithium ions. The positive electrode active material contains secondary particles. The secondary particle is an aggregate of primary particles and a silicon oxide. The primary particles contain a lithium nickel composite oxide. The silicon oxide is present in at least grain boundaries of the primary particles.

A lithium nickel composite oxide is a lithium-containing transition metal oxide with nickel as its essential element. Lithium nickel composite oxides have relatively low thermal stability, but by disposing a silicon oxide between the primary particles, the thermal stability improves significantly. Since lithium nickel composite oxides have high energy density, an excellently high performance battery can be obtained by improving the thermal stability.

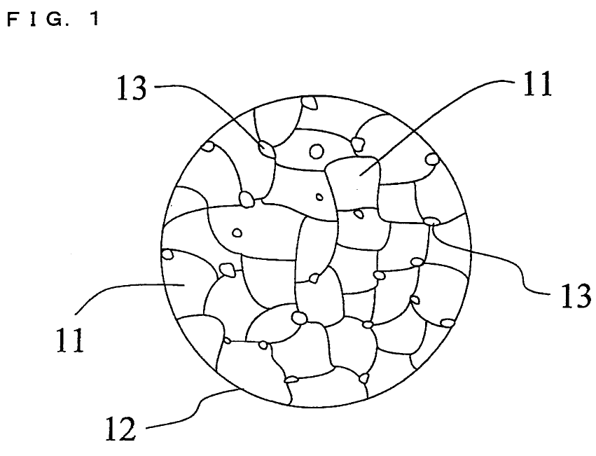

FIG. 1 is a diagram conceptually illustrating an example of the microstructure of a secondary particle. In FIG. 1, primary particles 11 are aggregated to form a secondary particle 12. A silicon oxide 13 is attached to the grain boundaries between the primary particles 11, that is, inside the secondary particle 12, and to the surface of the secondary particle 12.

In the present invention, the grain boundaries between the primary particles refer to the interfaces between adjacent primary particles. The grain boundaries between the primary particles are present on the surface of and inside the secondary particle. When the primary particles are aggregated to form the active material particles (secondary particles), many of the active points of the secondary particle are present particularly at the interface of different phases, that is, at the grain boundaries between the primary particles. Thus, it seems that the side reactions that cause abnormal heat generation at the time of an internal short circuit tend to advance at the grain boundaries between the primary particles. The inventors of the present invention have found out that the side reactions that cause abnormal heat generation at the time of an internal short circuit are curbed by the presence of a silicon oxide at the grain boundaries between the primary particles.

Although the details of the mechanism of effectively curbing the side reactions by silicon oxides are unclear, the following may be a possible explanation. A silicon oxide is present at the grain boundaries between the primary particles on the surface of or inside the secondary particle. An oxygen defect is present at the grain boundaries between the primary particles, and such an oxygen defect tends to cause an interaction with the silicon oxide. On the other hand, a silicon oxide also has an oxygen defect, and the oxygen defect of a silicon oxide tends to cause an interaction with a lithium nickel composite oxide. Furthermore, silicon oxides do not affect the charge and discharge reaction of the positive electrode active material. Therefore, with the presence of a silicon oxide at the grain boundaries between the primary particles, the oxygen defect at the grain boundaries decreases significantly, the grain boundaries are stabilized, and oxygen adsorption from the atmosphere is curbed. This seems to inhibit the side reactions that cause abnormal heat generation at the time of an internal short circuit.

The average particle size of the silicon oxide is preferably 0.005 to 1 μm because the effect of stabilizing the grain boundaries between the primary particles is highly achieved. The composition of the silicon oxide preferably satisfies SiOₐ (1≦a≦2), without limitation.

The shape of the secondary particles is preferably substantially spherical. A positive electrode active material containing substantially spherical secondary particles is higher in thermal stability than a positive electrode active material containing secondary particles that are not substantially spherical (for example, massive or indefinite-shaped secondary particles). This is related with the fact that a silicon oxide is preferentially attached to the grain boundaries between the particles. Although the details are unclear, the following may be a possible explanation.

More grain boundaries are present on the surface of massive secondary particles than substantially spherical secondary particles. Therefore, when the secondary particles are in a massive form, a silicon oxide is preferentially attached to the surface of the secondary particles, and then afterwards, attached to the grain boundaries between the primary particles.

On the other hand, substantially spherical secondary particles have a smaller surface area than that of massive secondary particles, and therefore the grain boundaries present on the surface thereof will be smaller in number. Thus, the amount of the silicon oxide attached to the surface of the secondary particles will decrease, and a larger amount of the silicon oxide would be attached to the grain boundaries between the primary particles. As a result, thermal stability in substantially spherical secondary particles improves more significantly than in the case of massive secondary particles.

Also, since many grain boundaries between the primary particles are present on the surface of massive secondary particles, it is probably difficult to allow a silicon oxide to be attached to all the grain boundaries. Therefore, it is highly probable that there remain the grain boundaries between the primary particles with no silicon oxide attached.

The circularity of the substantially spherical secondary particles is preferably 0.88 or more. The circularity of the particles can be measured, for example, by SEM (scanning electron microscope) image processing. For example, an average of the circularity of the particles is obtained for arbitrary 100 particles having a circle-equivalent diameter that is the same as the average particle size of the secondary particles. The circle-equivalent diameter is a diameter of a circle having the same area as that of the orthographic projection area of the particles.

The average particle size (50% value (D50): median diameter in volume-based particle size distribution) of the secondary particles is preferably 1 μm to 30 μm. The average particle size may be measured, for example, by using a laser diffraction particle size distribution meter. However, the method for measuring the average particle size is not limited to the above.

The average particle size of the primary particles is preferably 0.5 to 2 μm. The average particle size of the primary particles is Feret's diameter measured by, for example, using a counting method based on an electron microscope observation. The ratio of the average particle size of the primary particles r₁ to the average particle size of the secondary particles r₂ (r₁/r₂) preferably satisfies 0.001≦r₁/r₂≦0.12.

The lithium nickel composite oxide is preferably represented by LiₓNi_{1-y-z}Co_{y}Me_{z}O₂ where 0.85≦x≦1.25, 0≦y≦0.5, 0≦z≦0.5, 0<y+z≦0.75, and Me is at least one selected from the group consisting of Al, Mn, Ti, and Ca.

The value of x increases and decreases along with battery charge and discharge. When the value of y exceeds 0.5, sufficient high capacity may not be obtained. In view of achieving both excellent battery performance and safety, the value of y is further preferably 0.05≦y≦0.25, and still further preferably 0.08≦y≦0.2. Also, when the value of z exceeds 0.5, sufficient capacity may not be obtained. In view of achieving both excellent battery performance and safety, the value of z is further preferably 0.001≦z≦0.1, and still further preferably 0.005≦z≦0.05. That is, the value of y+z is particularly preferably 0.085≦y+z≦0.25.

With the lithium nickel composite oxide containing Co, the irreversible capacity can be decreased. By allowing the lithium nickel composite oxide to contain Me, thermal stability further improves. Me may contain a single element, or may contain any combination of plural elements.

In the present invention, the atomic ratio of the silicon element contained in the silicon oxide relative to the metal element other than lithium contained in the lithium nickel composite oxide is named D(s). D(s) preferably satisfies 0.0002≦D(s)≦0.05, that is, 0.0002≦(Si)/(Ni+Co+Me)≦0.05.

Furthermore, the conductivity of the secondary particles under a load of 40 N/cm² is preferably 0.07 S/cm or less, and more preferably 0.001 to 0.05 S/cm. Particularly, the conductivity of the secondary particles is preferably 0.01 to 0.03 S/cm.

With the presence of silicon, lithium ions diffuse from the surface of the secondary particles, which reduces the conductivity of the secondary particles.

When D(s) is below 0.0002, the amount of the silicon element attached is small, and therefore the effects of improving thermal stability may not be obtained sufficiently. On the other hand, when D(s) exceeds 0.05, the positive electrode active material surface may be covered excessively by the silicon oxide. Since the silicon oxide will not be involved in charge/discharge reactions, when the silicon oxide is attached to the active material surface excessively, high-rate performance at low temperature may decline. The amount of the silicon oxide to be attached may be small, but in view of improving lithium ion diffusion, it is further preferably 0.0003≦D(s)≦0.02.

When the conductivity exceeds 0.07 S/cm, the capacity retention rate at the time of overcharge may decline, and battery temperature at the time of nail penetration test may become high. The conductivity of the lithium nickel composite oxide may be measured, for example, by using a direct current four-terminal method.

In view of making the preparation of the positive electrode active material easy, the raw material for the positive electrode active material preferably contains a solid solution containing a plurality of metal elements. As the solid solution, for example, an oxide, a hydroxide, an oxyhydroxide, a carbonate, a nitrate, and an organic complex salt may be used. Particularly, using a solid solution containing Ni, Co, and Me is preferable because a compound containing Me does not have to be used. Furthermore, a solid solution containing silicon can also be used. The raw material may be used singly, or may be used in combination of two or more.

As the raw material for the silicon oxide, for example, an oxide or organic complex salt containing silicon may be used. The raw material of the silicon oxide is baked in an oxidizing atmosphere along with the raw material of the positive electrode active material. In this way, a positive electrode active material with a silicon oxide present at the grain boundaries between the primary particles can be obtained.

The positive electrode active material with a silicon oxide at the grain boundaries between the primary particles can be prepared, for example, by using the following method.

First, a compound containing nickel, a compound containing lithium, a compound containing silicon, and as necessary, a compound containing Me are mixed to prepare a mixture. Afterwards, by baking the mixture in an oxidizing atmosphere, a positive electrode active material with a silicon oxide preferentially attached to the grain boundaries between the primary particles can be prepared.

As the compound containing nickel, a hydroxide containing nickel is preferable. For example, nickel hydroxide; a coprecipitated hydroxide containing Ni and Co; a coprecipitated hydroxide containing Ni, Co, and Me; and a coprecipitated hydroxide containing Ni and Me are preferable.

The hydroxide containing nickel may be produced as a precipitate, for example, by mixing a raw material solution containing nickel sulfate with an aqueous solution of sodium hydroxide. When producing the precipitate, for example, by violently stirring the solution, a hydroxide that can provide a positive electrode active material with a circularity of the particles of 0.88 or more can be obtained.

Examples of the compound containing lithium include lithium hydroxide, lithium carbonate, lithium oxide, and lithium nitrate. Example of the compound containing silicon includes, SiOₐ (1≦a≦2) with an average particle size of 0.005 to 1 μm.

Although the baking temperature and the partial pressure of oxygen in the oxidizing atmosphere depend on the composition and amount of the raw material, and synthesizing apparatus, those in the art can select appropriate conditions. Air may be used as the oxidizing atmosphere, but the baking period becomes longer, which may reduce baking efficiency. In view of accelerating the baking reaction, the partial pressure of oxygen of the oxidizing atmosphere is preferably 0.4 atmospheric pressure to 1.0 atmospheric pressure. The baking temperature is preferably 700 to 900° C.

Lithium nickel composite oxide may contain impurities in a range that is normal in the industrial manufacturing processes. Such impurities do not affect the effects of the invention.

On the surface of the secondary particles contained in the positive electrode active material, an excessive amount of a lithium compound such as lithium hydroxide, lithium oxide, and lithium carbonate is present. When such a lithium compound is present excessively on the surface, sometimes the compound reacts with moisture or carbon dioxide in the air to produce lithium carbonate. Therefore, the positive electrode active material is preferably washed after the above-described steps to remove the lithium compound. The lithium nickel composite oxide is preferably washed, for example, by using a cleaning liquid, although the method for removing the lithium compound is not particularly limited thereto.

As the cleaning liquid, an aqueous alkaline solution substantially not containing lithium ions is preferably used, but not limited thereto. Examples of the method for washing the positive electrode active material are described in the following.

An aqueous alkaline solution and a positive electrode active material are mixed to make a slurry. It is preferable that the aqueous alkaline solution does not substantially contain lithium ions. At this time, the amount of the positive electrode active material relative to 1 L of the aqueous alkaline solution is set to 300 g to 3000 g. After stirring this slurry for more than 5 minutes, dehydration and vacuum drying are carried out.

When the washing is carried out with an aqueous alkaline solution containing lithium ions, deposition of lithium hydroxide may occur on the surface of the washed lithium nickel composite oxide in the step of dehydrating and drying lithium nickel composite oxide. Lithium hydroxide becomes lithium oxide or lithium carbonate in the above-described dehydrating and drying step, which may reduce the activity on the surface of the lithium nickel composite oxide.

In view of curbing elusion of lithium ions from the positive electrode active material to the cleaning liquid (aqueous alkaline solution), the pH of the cleaning liquid is preferably kept at 7.1 or more. In the case of normal water, the pH is neutral to weakly-acidic. Therefore, when the positive electrode active material is mixed with the cleaning liquid to make a slurry, lithium ions easily elute from the secondary particles in the proximity of the positive electrode active material. Because the elution of lithium decreases the amount of lithium contained in the active material, the discharge capacity may decline.

The pH of the aqueous alkaline solution is preferably 7.1 to 11.2, and further preferably 7.6 to 10.8.

As the aqueous alkaline solution, an aqueous solution of ammonium hydroxide, an aqueous solution of sodium hydroxide, an aqueous solution of potassium hydroxide, and the like are used. Ammonium hydroxide is particularly preferable, because it is decomposed as ammonia gas during baking of the raw material of the lithium nickel composite oxide, which renders its removal from the positive electrode active material easy. The aqueous solution of ammonium hydroxide preferably has a concentration that is sufficient to maintain the above-described pH.

As the positive electrode, for example, a positive electrode material mixture carried on a positive electrode current collector is used. The positive electrode material mixture contains a positive electrode active material as an essential component, and contains, for example, a binder, a conductive material, and a thickener as optional components. For example, a positive electrode material mixture paste is applied on one or both sides of the positive electrode current collector. The positive electrode material mixture paste is prepared by mixing the positive electrode material mixture with a liquid dispersion medium. Afterwards, the coating is dried and rolled to form a positive electrode material mixture layer, thereby obtaining a positive electrode.

Examples of the binder for the positive electrode include a thermoplastic resin and a thermosetting resin. The thermoplastic resin is preferably used. Examples of the thermoplastic resin include polyethylene, polypropylene, polytetrafluoroethylene (PTFE), polyvinylidene fluoride (PVDF), styrene butadiene rubber, a tetrafluoroethylene-hexafluoropropylene copolymer (FEP), a tetrafluoroethylene-perfluoroalkylvinylether copolymer (PFA), a vinylidene fluoride-hexafluoropropylene copolymer, a vinylidene fluoride-chlorotrifluoroethylene copolymer, an ethylene-tetrafluoroethylene copolymer (ETFE), a polychlorotrifluoroethylene (PCTFE), a vinylidene fluoride-pentafluoropropylene copolymer, a propylene-tetrafluoroethylene copolymer, an ethylene-chlorotrifluoroethylene copolymer (ECTFE), a vinylidene fluoride-hexafluoropropylene-tetrafluoroethylene copolymer, an ethylene-acrylic acid copolymer, an ethylene-methacrylic acid copolymer, an ethylene-methyl acrylate copolymer, and an ethylene-methyl methacrylate copolymer. These may used singly, or may be used in combination of two or more. These resins may be cross-linked, for example by Na ions.

As the conductive material for the positive electrode, an electron conductive material that is chemically stable in the battery is preferably used. For example, graphites such as natural graphite (flake graphite, etc.) and artificial graphite; carbon blacks such as acetylene black, ketjen black, channel black, furnace black, lamp black, and thermal black; conductive fibers such as carbon fiber and metal fiber; powder of metal such as aluminum powder; conductive whiskers such as zinc oxide and potassium titanate; a conductive metal oxide such as titanium oxide; an organic conductive material such as a polyphenylene derivative; and fluorocarbon may be used. Those conductive materials for the positive electrode may be used singly, or may be used in combination of two or more. The amount of the conductive material for the positive electrode to be added is preferably 1 to 50 wt % relative to the positive electrode active material. The amount of the conductive material to be added is further preferably 1 to 30 wt %, and particularly preferably 2 to 15 wt %.

As the positive electrode current collector, an electronic conductor that is chemically stable in the battery is preferably used. For example, foil or a sheet containing aluminum, stainless steel, nickel, titanium, carbon, or a conductive resin may be used. A layer containing carbon or titanium, and an oxide layer may be formed on the surface of the positive electrode current collector. Projections and depressions may be formed on the current collector surface. As the positive electrode current collector, a net, a punched sheet, a lath, a porous body, a foam body, and a fibrous molded body may also be used. The thickness of the positive electrode current collector is, for example, 1 to 500 μm.

In the following, constituents other than the positive electrode are described. Note that the characteristics of the non-aqueous electrolyte secondary battery of the present invention reside in its positive electrode as described above, and there is no particular limitation on other constituents. Therefore, the following description does not limit the present invention.

As the negative electrode, for example, a negative electrode material mixture carried on a negative electrode current collector is used. The negative electrode material mixture contains a negative electrode active material as an essential component, and contains, for example, a binder, a conductive material, and a thickener as optional components. The negative electrode may be made, for example, in the same manner as the method for preparing the positive electrode.

There is no limitation on the negative electrode active material, as long as a material capable of absorbing and desorbing lithium ions is used. For example, graphites, a non-graphitizable carbon material, a metal lithium, and a lithium alloy may be used. As the lithium alloy, particularly, an alloy containing at least one selected from the group consisting of silicon, tin, aluminum, titanium, zinc, and magnesium is preferable. The average particle size of the negative electrode active material is, for example, 1 to 30 μm.

There is no limitation on the binder for the negative electrode. For example, those shown as examples of the binder for the positive electrode may be freely selected and used. The binder for the negative electrode may be used singly, or may be used in combination of two or more.

As the conductive material for the negative electrode, an electron conductive material that is chemically stable in the battery is preferably used. For example, graphites such as natural graphite (flake graphite, etc.) and artificial graphite; carbon blacks such as acetylene black, ketjen black, channel black, furnace black, lamp black, and thermal black; conductive fibers such as carbon fiber and metal fiber; powder of metal such as copper powder and nickel powder; and an organic conductive material such as a polyphenylene derivative may be used. Those conductive materials for the negative electrode may be used singly, or may be used in combination of two or more. The amount of the conductive material for the negative electrode to be added is preferably 1 to 30 wt %, and further preferably 1 to 10 wt % relative to the negative electrode active material.

As the negative electrode current collector, an electronic conductor that is chemically stable in the battery is preferably used. For example, foil or a sheet containing stainless steel, nickel, copper, titanium, carbon, or a conductive resin may be used. Particularly, copper and a copper alloy are preferably used. A layer containing, for example, carbon, titanium, or nickel, and an oxide layer may be formed on the surface of the negative electrode current collector. Projections and depressions may be formed on the current collector surface. As the negative electrode current collector, a net, a punched sheet, a lath, a porous body, a foam body, and a fibrous molded body may also be used. The thickness of the negative electrode current collector is, for example, 1 to 500 μm.

The non-aqueous electrolyte is not particularly limited. For example, any of liquid, gelled, or solid electrolyte or polymer solid electrolyte may be used.

The liquid non-aqueous electrolyte (non-aqueous electrolytic solution) contains a non-aqueous solvent and a solute. There is no particular limitation on the non-aqueous solvent. For example, a known non-aqueous solvent such as cyclic carbonate, non-cyclic carbonate, and cyclic carboxylate may be used. Examples of the cyclic carbonate include propylene carbonate (PC) and ethylene carbonate (EC). Examples of the non-cyclic carbonate include diethyl carbonate (DEC), ethyl methyl carbonate (EMC), and dimethyl carbonate (DMC). These non-aqueous solvents may be used singly, or may be used in combination of two or more.

As the solute, a lithium salt may be used. For example, LiClO₄, LiBF₄, LiPF₆, LiAlCl₄, LiSbF₆, LiSCN, LiCF₃SO₃, LiCF₃CO₂, Li(CF₃SO₂)₂, LiAsF₆, LiB₁₀Cl₁₀, lithium lower aliphatic carboxylate, LiCl, LiBr, LiI, chloroboran lithium, borates, and imide salts may be used. These solutes may be used singly, or may be used in combination of two or more.

The non-aqueous electrolyte may further include an additive. The additive has a function of, for example, forming a coating film with high lithium ion conductivity by being decomposed on the negative electrode. In this way, battery charge and discharge efficiencies can be improved further. Examples of the additives with such a function include vinylene carbonate (VC), 3-methylvinylene carbonate, 3,4-dimethylvinylene carbonate, 3-ethylvinylene carbonate, 3,4-diethylvinylene carbonate, 3-propylvinylene carbonate, 3,4-dipropylvinylene carbonate, 3-phenylvinylene carbonate, 3,4-diphenylvinylene carbonate, vinylethylene carbonate (VEC), and divinyl ethylene carbonate. These may be used singly, or may be used in combination of two or more. Particularly, at least one selected from the group consisting of vinylene carbonate, vinyl ethylene carbonate, and divinyl ethylene carbonate is further preferably used.

The gelled non-aqueous electrolyte contains, for example, a non-aqueous electrolyte and a polymer material holding the non-aqueous electrolyte. As the polymer material, for example, polyvinylidene fluoride, polyacrylonitrile, polyethyleneoxide, polyvinyl chloride, polyacrylate, and a vinylidene fluoride-hexafluoropropylene copolymer are preferably used.

A separator is interposed between the positive electrode and the negative electrode. As the separator, for example, a microporous thin film, woven fabric, and nonwoven fabric having ion permeability, mechanical strength, and insulating property are used. As the separator material, for example, sheet or nonwoven fabric made of polyolefin such as polypropylene or polyethylene, or made of glass fiber is used. Particularly, in view of improving safety in non-aqueous electrolyte secondary batteries, polyolefin is preferable because it has excellent durability, and also has a function of closing the pores upon reaching a certain temperature to increase resistance (shutdown function). The separator may be a single-layer film composed of a single material, or a composite film or multi-layer film containing two or more materials.

The thickness of the separator is not particularly limited. Although the thickness is generally 5 to 300 μm, the thickness is preferably 40 μm or less. The thickness is further preferably 5 to 30 μm, and still further preferably 10 to 25 μm. The pore diameter of the separator is, for example, 0.01 to 1 μm. The porosity of the separator is, for example, 30 to 80%.

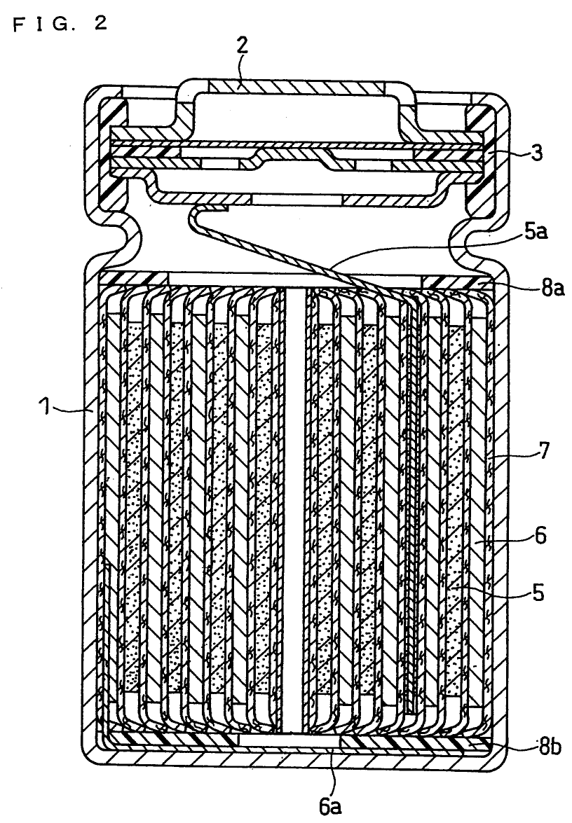

A non-aqueous electrolyte secondary battery in one embodiment of the present invention is described with reference to FIG. 2. FIG. 2 is a vertical cross sectional view of a cylindrical non-aqueous electrolyte secondary battery.

The non-aqueous electrolyte secondary battery includes an electrode assembly including a positive electrode 5, a negative electrode 6, and a separator 7; a non-aqueous electrolyte; and a case 1 for encapsulating the assembly and the electrolyte. The positive electrode 5 and the negative electrode 6 are wound with the separator 7 interposed therebetween, and housed in the cylindrical case 1. On top and bottom of the electrode assembly, an upper insulation ring 8a, and a lower insulation ring 8b are disposed. One end of a positive electrode lead 5a is connected to the positive electrode 5, and one end of a negative electrode lead 6a is connected to the negative electrode 6. A sealing plate 2 also functions as an outer terminal. The other end of the positive electrode lead 5a is connected to the rear face of the sealing plate 2. The other end of the negative electrode lead 6a is connected to the inner bottom face of the case 1. At the periphery of the sealing plate 2 for sealing an opening of the case 1, a gasket 3 is provided, and an opening end of the case 1 is crimped on the gasket 3. The non-aqueous electrolyte secondary battery is thus completed.

Although a cylindrical non-aqueous electrolyte secondary battery is described in the above embodiment, the shape of the battery is not limited thereto. For example, the battery may be any of coin-type, button-type, sheet-type, flat-type, or prismatic-type battery. The electrode assembly may be a wound-type or a stack-type.

### EXAMPLES

The present invention is described in detail by using examples and comparative examples. However, the subject matter of the present invention is not limited thereto.

### Example 1

### (i) Positive Electrode Active Material Preparation

Nickel sulfate, cobalt sulfate, and aluminum sulfate were mixed so that the molar ratio of Ni atoms, Co atoms, and Al atoms was 80:15:5. The obtained mixture in an amount of 3.2 kg was dissolved in 10 L of water to prepare a raw material solution. The raw material solution was mixed with 400 g of sodium hydroxide and stirred sufficiently. A precipitate generated at this time was washed with water sufficiently and dried, to obtain a Ni—Co—Al coprecipitated hydroxide.

To 3000 g of the Ni—Co—Al coprecipitated hydroxide, 784 g of lithium hydroxide and 1.3 g of silicon dioxide (average particle size: 1 μm) were mixed, and the mixture was baked for 24 hours in an atmosphere with a partial pressure of oxygen of 0.5 atmospheric pressure. The baking temperature was set to 750° C. A lithium nickel composite oxide (LiNi_{0.8}Co_{0.15}Al_{0.05}O₂) containing Al as element Me was thus obtained.

The theoretical value of atomic ratio D(s) of silicon element contained in silicon oxide relative to the metal element other than lithium in the lithium nickel composite oxide, that is, (Si)/(Ni+Co+Al) was 0.0002. The atomic ratio (measured value) obtained from the thus obtained active material was 0.00019.

### (ii) Positive Electrode Active Material Washing

To 1 L of an aqueous solution of 0.1 wt % ammonium hydroxide, 1000 g of the positive electrode active material was added to make a slurry. After stirring the slurry for 15 minutes, the slurry was dehydrated and vacuum-dried at 150° C. for 24 hours. Under the condition of 25° C., the pH (hydrogen ion concentration) of the aqueous solution of ammonium hydroxide was 10.6. The conductivity of the aqueous solution of ammonium hydroxide was 21.3 mS/m.

As a result of an SEM (scanning microscope) analysis, it was found that the silicon oxide was attached to the grain boundaries between the primary particles. Also, a sputtering was carried out to obtain a cross section of the secondary particles, and the cross section was observed. As a result, it was confirmed that the silicon oxide was also present at the interfaces between the primary particles present inside the secondary particle. When the average particle size of the active material (secondary particle) was measured by using a particle size distribution meter, it was found that the average particle size was 12 μm. When the average particle size of twelve primary particles was measured by using SEM, it was found that the average particle size was 1 μm. When the circularity was obtained for 100 secondary particles having a circle-equivalent diameter of 12 μm by SEM image processing, it was found that the average value was 0.90.

The conductivity of the secondary particles was measured by a direct current four-terminal method. To be specific, a pressure of 40 N/cm² was applied to the secondary particles. Under this condition, an electric current was allowed to pass through the secondary particles by connecting terminals thereto, and the conductivity was obtained from the potential differences between the terminals.

### (iii) Positive Electrode Preparation

A positive electrode material mixture paste was prepared by mixing 1 kg of the positive electrode active material, 0.5 kg of PVDF #1320 manufactured by Kureha corporation (N-methyl-2-pyrrolidone (NMP) solution containing 12 wt % of PVDF), 40 g of acetylene black, and an appropriate amount of NMP with a double-armed kneader. The positive electrode material mixture paste was applied on both sides of a positive electrode current collector, i.e., aluminum foil with a thickness of 20 μm; dried; and rolled to give a total thickness of 160 μm. Afterwards, the rolled electrode plate was cut to give a width that can be inserted into a battery case of cylindrical type 18650, thereby making a positive electrode.

### (iv) Negative Electrode Preparation

A negative electrode material mixture paste was prepared by mixing 3 kg of artificial graphite (MAG graphite manufactured by Hitachi Chemical Co., Ltd.), 200 g of BM-400 manufactured by Zeon Corporation (an aqueous dispersion containing 40 wt % of modified styrene-butadiene rubber), 50 g of carboxymethyl cellulose (CMC), and an appropriate amount of water with a double-armed kneader. The negative electrode material mixture paste was applied on both sides of a negative current collector, i.e., copper foil with a thickness of 12 μm; dried; and rolled to give a total thickness of 160 μm. Afterwards, the rolled electrode plate was cut to give a width that can be inserted into a battery case of cylindrical type 18650, thereby making a negative electrode.

### (v) Non-Aqueous Electrolyte Preparation

A non-aqueous electrolyte was made by dissolving lithium hexafluorophosphate (LiPF₆) in a 1:3 volume ratio solvent mixture of ethylene carbonate and methyl ethyl carbonate with a concentration of 1.5 mol/L.

### (vi) Battery Assembly

A non-aqueous electrolyte secondary battery as shown in FIG. 2 was made. An electrode assembly was made by winding the positive electrode 5 and the negative electrode 6 with the positive electrode lead 5a and the negative electrode lead 6a respectively attached thereto with the separator 7 interposed therebetween. As the separator 7, a composite film made of polyethylene and polypropylene (2300 manufactured by Celgard Inc., a separator with a thickness of 25 μm) was used. The electrode assembly was inserted into the case 1, and the leads were connected. After injecting the non-aqueous electrolyte into the case 1, the opening of the case 1 was sealed with the sealing plate 2, thereby making a non-aqueous electrolyte secondary battery with a diameter of 18 mm and a height of 65 mm (size 18650).

### Example 2

A battery was made in the same manner as in Example 1, except that silicon dioxide was used in an amount satisfying D(s)=0.001 when making the positive electrode active material.

### Example 3

A battery was made in the same manner as in Example 1, except that silicon dioxide was used in an amount satisfying D(s)=0.001 when making the positive electrode active material.

### Example 4

A battery was made in the same manner as in Example 1, except that silicon dioxide was used in an amount satisfying D(s)=0.02 when making the positive electrode active material.

### Example 5

A battery was made in the same manner as in Example 1, except that silicon dioxide was used in an amount satisfying D(s)=0.05 when making the positive electrode active material.

### Example 6

A battery was made in the same manner as in Example 1, except that silicon monoxide (SiO) was used in an amount satisfying D(s)=0.01 instead of silicon dioxide when making the positive electrode active material.

### Example 7

A battery was made in the same manner as in Example 1, except that silicon was added in an amount satisfying D(s)=0.01 instead of silicon dioxide when making the positive electrode active material. In this case, silicon was oxidized at the time of baking to produce a silicon oxide.

### Example 8

A battery was made in the same manner as in Example 1, except that silicon dioxide was used in an amount satisfying D(s)=0.01 when making the positive electrode active material; and the concentration of the aqueous solution of ammonium hydroxide was set to 0.2 wt % when washing the positive electrode active material.

### Example 9

A battery was made in the same manner as in Example 1, except that silicon dioxide was used in an amount satisfying D(s)=0.01 when making the positive electrode active material; and the amount of the positive electrode active material relative to 1 L of the aqueous solution of ammonium hydroxide was set to 500 g when washing the positive electrode active material.

### Example 10

A battery was made in the same manner as in Example 1, except that silicon dioxide was used in an amount satisfying D(s)=0.01 when making the positive electrode active material; and the amount of the positive electrode active material relative to 1 L of the aqueous solution of ammonium hydroxide was set to 2000 g when washing the positive electrode active material.

### Example 11

A battery was made in the same manner as in Example 1, except that silicon dioxide was used in an amount satisfying D(s)=0.01 when making the positive electrode active material; and an aqueous solution of sodium hydroxide was used instead of ammonium hydroxide, the concentration of the aqueous solution of sodium hydroxide was set to 0.1 wt %, and the amount of the positive electrode active material relative to 1 L of the aqueous solution of sodium hydroxide was set to 1000 g when washing the positive electrode active material.

### Example 12

A battery was made in the same manner as in Example 1, except that the composition of the lithium nickel composite oxide was changed to LiNi_{0.25}Co_{0.70}Al_{0.05}O₂, and silicon dioxide was used in an amount satisfying D(s)=0.01 when making the positive electrode active material.

### Example 13

A battery was made in the same manner as in Example 1, except that the composition of the lithium nickel composite oxide was changed to LiNi_{0.20}CO_{0.75}Al_{0.05}O₂, and silicon dioxide was used in an amount satisfying D(s)=0.01 when making the positive electrode active material.

### Example 14

A battery was made in the same manner as in Example 1, except that silicon dioxide was used in an amount satisfying D(s)=0.1 when making the positive electrode active material.

### Comparative Example 1

A battery was made in the same manner as in Example 1, except that silicon dioxide was not used when making the positive electrode active material.

### Comparative Example 2

A battery was made in the same manner as in Example 1, except that silicon dioxide was not used when making the positive electrode active material; and an aqueous solution of lithium hydroxide was used instead of the aqueous solution of ammonium hydroxide, the concentration of the aqueous solution of lithium hydroxide was set to 0.1 wt %, and the amount of the positive electrode active material relative to 1 L of the aqueous solution of lithium hydroxide was set to 1000 g when washing the positive electrode active material.

### Comparative Example 3

A battery was made in the same manner as in Example 1, except that silicon dioxide was not used when making the positive electrode active material, and the washing of the positive electrode active material was not carried out.

### Comparative Example 4

A battery was made in the same manner as in Example 1, except that alumina (average particle size: 0.5 μm) was added instead of silicon dioxide when making the positive electrode active material, and the washing of the positive electrode active material was not carried out.

### Comparative Example 5

A battery was made in the same manner as in Example 1, except for the following: the secondary particles were synthesized without adding silicon dioxide when baking the Ni—Co—Al coprecipitated hydroxide and lithium hydroxide; the obtained secondary particles and the silicon dioxide powder were mixed so as to achieve D(s)=0.01 and this mixture was used as the positive electrode active material; and the washing of the positive electrode active material was not carried out.

### [Evaluation]

The batteries of Examples 1 to 14, and of Comparative Examples 1 to 5 (nominal capacity 2800 mAh) were evaluated as follows.

### (Evaluation of Discharge Performance)

Preliminary charge and discharge were carried out twice for each battery, and afterwards, the batteries were stored for 2 days in a 40° C. environment. Afterwards, the following two patterns of charge and discharge were carried out for each battery. The nominal capacity of the battery, i.e., 2800 in Ah, was regarded as 1 C mAh. The results are shown in Table 1.

### First Pattern

(1) Constant Current Charge (20° C.): 0.7 C mA (End Voltage 4.2 V)

(2) Constant Voltage Charge (20° C.): 4.2 V (End Current 0.05 C mA)

(3) Constant Current Discharge (0° C.): 0.2 C mA (End Voltage 3.0 V)

### Second Pattern

(1) Constant Current Charge (20° C.): 0.7 C mA (End Voltage 4.2 V)

(2) Constant Voltage Charge (20° C.): 4.2 V (End Current 0.05 C mA)

(3) Constant Current Discharge (0° C.): 2 C mA (End Voltage 3.0 V)

### (Evaluation of Safety)

A nail penetration test was carried out under the following conditions to evaluate safety at the time of internal short circuit occurrence.

First, these batteries after the evaluation of discharge performance were charged in an environment of 20° C. under the following conditions.

(1) Constant Current Charge: 0.7 C mA (End Voltage 4.25 V)

(2) Constant Voltage Charge: 4.25 V (End Current 0.05 C mA)

A stainless steel nail was stuck in at the center portion of the side face of each of the charged batteries by using a hydraulic press until the nail penetrated through the battery in an environment of 25° C. The highest temperature reached in the battery was measured at that time. The results are shown in Table 1.

TABLE 1

| | | | | | | | | | Nail | | |
|---|---|---|---|---|---|---|---|---|---|---|---|
| | | | | | Aqueous Alkaline Solution | | | | Penetration | | |
| | | | Par- | | | | Amount of | Conductivity | Test | | |
| | | | ticle | | | | Positive | of | Highest | 0.2 CmA | 2 CmA |
| | | Addi- | Cir- | | | Concen- | Electrode | Secondary | Temperature | Discharge | Discharge |
| | Positive Electrode | tive | cular- | | | tration | Active | Particle | Reached | Capacity | Capacity |
| | Active Material | Type | ity | D(s) | Solute | (wt %) | Material (g) | (S/cm) | (° C.) | (mAh) | (mAh) |
| Example 1 | LiNi_{0.8}Co_{0.15}Al_{0.05}O₂ | SiO₂ | 0.90 | 0.0002 | NH₄OH | 0.1 | 1000 | 0.016 | 103 | 2905 | 2324 |
| Example 2 | LiNi_{0.8}Co_{0.15}Al_{0.05}O₂ | SiO₂ | 0.91 | 0.001 | NH₄OH | 0.1 | 1000 | 0.013 | 97 | 2898 | 2318 |
| Example 3 | LiNi_{0.8}Co_{0.15}Al_{0.05}O₂ | SiO₂ | 0.91 | 0.01 | NH₄OH | 0.1 | 1000 | 0.013 | 94 | 2886 | 2309 |
| Example 4 | LiNi_{0.8}Co_{0.15}Al_{0.05}O₂ | SiO₂ | 0.91 | 0.02 | NH₄OH | 0.1 | 1000 | 0.012 | 91 | 2883 | 2306 |
| Example 5 | LiNi_{0.8}Co_{0.15}Al_{0.05}O₂ | SiO₂ | 0.89 | 0.05 | NH₄OH | 0.1 | 1000 | 0.007 | 102 | 2864 | 2291 |
| Example 6 | LiNi_{0.8}Co_{0.15}Al_{0.05}O₂ | SiO | 0.92 | 0.01 | NH₄OH | 0.1 | 1000 | 0.010 | 96 | 2883 | 2306 |
| Example 7 | LiNi_{0.8}Co_{0.15}Al_{0.05}O₂ | Si | 0.90 | 0.01 | NH₄OH | 0.1 | 1000 | 0.015 | 97 | 2876 | 2301 |
| Example 8 | LiNi_{0.8}Co_{0.15}Al_{0.05}O₂ | SiO₂ | 0.91 | 0.01 | NH₄OH | 0.2 | 1000 | 0.014 | 92 | 2871 | 2297 |
| Example 9 | LiNi_{0.8}Co_{0.15}Al_{0.05}O₂ | SiO₂ | 0.89 | 0.01 | NH₄OH | 0.1 | 500 | 0.019 | 99 | 2877 | 2302 |
| Example 10 | LiNi_{0.8}Co_{0.15}Al_{0.05}O₂ | SiO₂ | 0.89 | 0.01 | NH₄OH | 0.1 | 2000 | 0.013 | 93 | 2880 | 2304 |
| Example 11 | LiNi_{0.8}Co_{0.15}Al_{0.05}O₂ | SiO₂ | 0.88 | 0.01 | NaOH | 0.1 | 1000 | 0.025 | 108 | 2884 | 2307 |
| Example 12 | LiNi_{0.8}Co_{0.15}Al_{0.05}O₂ | SiO₂ | 0.91 | 0.01 | NH₄OH | 0.1 | 1000 | 0.015 | 96 | 2898 | 2318 |
| Example 13 | LiNi_{0.8}Co_{0.15}Al_{0.05}O₂ | SiO₂ | 0.91 | 0.01 | NH₄OH | 0.1 | 1000 | 0.014 | 106 | 2901 | 2321 |
| Example 14 | LiNi_{0.8}Co_{0.15}Al_{0.05}O₂ | SiO₂ | 0.88 | 0.1 | NH₄OH | 0.1 | 1000 | 0.003 | 101 | 2870 | 2295 |
| Com. Ex. 1 | LiNi_{0.8}Co_{0.15}Al_{0.05}O₂ | Not | 0.86 | — | NH₄OH | 0.1 | 1000 | 0.038 | 111 | 2909 | 2324 |
| | | Used | | | | | | | | | |
| Com. Ex. 2 | LiNi_{0.8}Co_{0.15}Al_{0.05}O₂ | Not | 0.84 | — | LiOH | 0.1 | 1000 | 0.077 | 113 | 2902 | 2320 |
| | | Used | | | | | | | | | |
| Com. Ex. 3 | LiNi_{0.8}Co_{0.15}Al_{0.05}O₂ | Not | 0.83 | — | Not | — | — | 0.091 | 120 | 2895 | 2318 |
| | | Used | | | Used | | | | | | |
| Com. Ex. 4 | LiNi_{0.8}Co_{0.15}Al_{0.05}O₂ | Al₂O₃ | 0.80 | 0.01 | Not | — | — | 0.116 | 128 | 2878 | 2300 |
| | | | | | Used | | | | | | |
| Com. Ex. 5 | LiNi_{0.8}Co_{0.15}Al_{0.05}O₂ | SiO₂ | 0.78 | 0.01 | Not | — | — | 0.280 | 148 | 2865 | 2273 |
| | | | | | Used | | | | | | |

In Examples 1 to 5, and 14, the amount of the silicon oxide was adjusted so as to vary the value of D(s). Table 1 shows that in Examples 1 to 5, the highest temperature reached was low compared with Example 14 at the time of the nail penetration test. This shows that D(s) is preferably 0.001 to 0.05. In Examples 2 to 4, the highest temperature reached was further low compared with Examples 1 and 5. That is, it can be seen that the battery safety further improves when D(s) is 0.001 to 0.02.

In Example 6, SiO was used as the silicon oxide. In Example 7, a silicon simple substance was added. Since silicon is oxidized at the time of synthesizing the lithium composite oxide, it seems that the oxygen defect itself was less, and the contribution to the lithium ion diffusion was decreased.

In Example 8, the concentration of the aqueous solution of ammonium hydroxide was set to 0.2 wt % when washing the positive electrode active material. From the results of Example 8, it is clear that a sufficient concentration of the aqueous alkaline solution is effective.

In Examples 9 and 10, the amount of the positive electrode active material added to 1 L of the aqueous solution of ammonium hydroxide was changed when washing the positive electrode active material. The results of Examples 9 and 10 indicate that the presence of the silicon oxide on the active material surface decreases when the amount of the active material is small and the relative amount of alkali is large at the time of washing. This seems to be the reason that the conductivity of the secondary particles was increased, and the highest temperature reached at the time of the nail penetration test became slightly high.

In Comparative Examples 1 to 3, silicon dioxide was not added to the positive electrode active material. The comparison between the results of the Comparative Examples 1 to 3 and those of the examples shows that the addition of silicon dioxide to the positive electrode active material achieves excellent safety.

In Comparative Example 4, alumina was added to the positive electrode active material instead of silicon dioxide. The comparison between the results in this comparative example and the examples shows that excellent safety can be achieved in the case when silicon dioxide is added to the positive electrode active material rather than alumina.

In Comparative Example 5, silicon dioxide powder was mixed in after preparing the positive electrode active material. In this case, it can be considered that silicon dioxide is not present at the grain boundaries between the primary particles. Consequently, safety declined.

As a result of the evaluations also carried out for the cases where various lithium nickel composite oxides were synthesized by using various raw materials instead of the Ni—Co—Al coprecipitated hydroxide, it was found that the same results with the battery using LiNi_{0.8}Co_{0.15}Al_{0.05}O₂ were obtained.

The present invention is useful for a non-aqueous electrolyte secondary battery containing a lithium nickel composite oxide as the positive electrode active material. There is no limitation to the battery size. The size may be small as those batteries used for small mobile devices, or may be large as those batteries used for electric cars and hybrid vehicles. There is no limitation to the use of the non-aqueous electrolyte secondary battery. For example, the present invention may be applied for power sources of personal digital assistants, mobile electronic devices, small-size household power storage devices, motorcycles, electric cars, and hybrid electric vehicles.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A non-aqueous electrolyte secondary battery comprising: a positive electrode; a negative electrode; a separator; and a non-aqueous electrolyte,
wherein said positive electrode includes a positive electrode active material capable of absorbing and desorbing lithium ions,
said positive electrode active material includes a secondary particle,
said secondary particle comprises an aggregate containing primary particles and a silicon oxide,
said primary particles include a lithium nickel composite oxide, and
said silicon oxide is present in at least grain boundaries between said primary particles.

2. The non-aqueous electrolyte secondary battery in accordance with claim 1, wherein said grain boundaries between said primary particles where said silicon oxide is present are present inside said secondary particle.

3. The non-aqueous electrolyte secondary battery in accordance with claim 1, wherein said lithium nickel composite oxide is represented by the general formula
LiₓNi_{1-y-z}Co_{y}Me_{z}O₂
where 0.85≦x≦1.25, 0≦y≦0.5, 0≦z≦0.5, 0<y+z≦0.75, and Me is at least one selected from the group consisting of Al, Mn, Ti, and Ca.

4. The non-aqueous electrolyte secondary battery in accordance with claim 1, wherein atomic ratio D(s) of silicon element contained in said silicon oxide relative to metal element other than lithium contained in said lithium nickel composite oxide satisfies 0.0002≦D(s)≦0.05, and the conductivity of said secondary particle under a load of 40 N/cm² is 0.07 S/cm or less.

5. The non-aqueous electrolyte secondary battery in accordance with claim 1, wherein said secondary particle is substantially spherical.

6. The non-aqueous electrolyte secondary battery in accordance with claim 5, wherein the circularity of said secondary particle is 0.88 or more.

7. A method for producing a non-aqueous electrolyte secondary battery, comprising the steps of:
mixing a compound containing nickel, a compound containing lithium, and a compound containing silicon to prepare a mixture; and
baking said mixture to prepare a positive electrode active material.

8. The method for producing a non-aqueous electrolyte secondary battery in accordance with claim 7, further comprising the steps of:
washing said positive electrode active material by mixing said positive electrode active material with an aqueous alkaline solution,
wherein said aqueous alkaline solution does not substantially contain lithium ions, and
the amount of said positive electrode active material relative to 1 L of said aqueous alkaline solution is 300 g to 3000 g.

9. A non-aqueous electrolyte secondary battery comprising a positive electrode; a negative electrode; a separator; and a non-aqueous electrolyte,
wherein said positive electrode includes a positive electrode active material obtained by baking a mixture of a compound containing nickel, a compound containing lithium, and a compound containing silicon,
said positive electrode active material contains a secondary particle,
said secondary particle comprises an aggregate containing primary particles and a silicon oxide,
said primary particles include a lithium nickel composite oxide, and
said silicon oxide is present in at least grain boundaries between said primary particles.
